(19) United States
(12) Patent Application Publication
(10) Pub. No.: US 2004/0027917 A1
(43) Pub. Date: Feb. 12, 2004

(54) Borehole logging apparatus for deep well drilling with a device for transmitting borehole measurement data

(75) Inventor: Helmut Winnacker, Burgdorf (DE)

Correspondence Address: WILLIAM COLLARD, COLLARD & ROE, P.C., 1077 NORTHERN BOULEVARD, ROSLYN, NY, 11576, US

(73) Assignee: Precision Drilling Technology Services GmbH

(21) Appl. No.: 10/634,452

(22) Filed: Aug. 5, 2003

Related U.S. Application Data
(63) Continuation-in-part of application No. 10/068,617, filed on Feb. 6, 2002.

(30) Foreign Application Priority Data
Feb. 8, 2001 (DE) 101 06 080.7
Aug. 7, 2002 (DE) 102 36 228.9

(51) Int. Cl. H04H 9/00; G01V 3/00

(52) U.S. Cl. 367/83; 340/854.3

(57) ABSTRACT

The invention is directed to a borehole logging apparatus for deep well drilling, with a signal transmitter for transmitting measured data obtained while drilling from a borehole through the drilling fluid to the earth's surface, and with an elongated housing which is adapted for insertion in the drilling fluid conduit of a drill string. Accommodated in the housing is a flow regulator with a control piston, which controls the cross-section of opening of a bypass opening in response to the pressure differential generated at an entrance opening of the housing and the force of a spring, in such manner that the part of the drilling fluid current delivered to the housing conduit, which is fed to the signal transmitter, is maintained substantially constant, and the remaining excess drilling fluid current is routed to the drilling fluid conduit via the bypass opening.

### BACKGROUND OF THE INVENTION

This invention relates to a borehole logging apparatus for deep well drilling, with a device for transmitting measured data obtained while drilling from a borehole to the earth's surface, with an elongated housing, which is adapted for insertion in the drilling fluid conduit of a drill string, includes at its influx end an entrance opening leading into a central housing conduit and has, downstream from the entrance opening, a sealing ring effecting a seal against the drill string, which further includes a bypass opening arranged downstream from the sealing ring and leading from the central housing conduit into the drilling fluid conduit of the drill string, and, downstream from the bypass opening, has a passageway connecting the central housing conduit with the drilling fluid conduit of the drill string, said passageway being adapted to be throttled at least in part by a controllable closure element of a hydromechanical signal transmitter arranged in the housing, said closure element being repeatedly movable, at controlled intervals and in response to signals characteristic of measured data to be transmitted, from a passing position into a throttling position and back again into the passing position in order to generate in the drilling fluid a coded series of positive pressure pulses corresponding to the signals.

In a borehole logging apparatus of the type referred to which is known from US-2002-0105858-A1 a flow regulator with a control piston is arranged in the housing. The flow regulator controls the cross-section of opening of the bypass opening in response to the pressure differential generated by a flow restrictor and the force of a spring, in such manner that the part of the drilling fluid current fed to the signal transmitter through the flow restrictor is maintained substantially constant, and the remaining excess drilling fluid current is routed to the drilling fluid conduit via the bypass opening. The control piston of the flow regulator has a throttling section controlling the cross-section of passage of the bypass opening, and a measuring section serving as a pressure sensor. The throttling section and the measuring section are interconnected by a tappet, and the throttling section disposed in the housing conduit disconnects the bypass opening from the signal transmitter and is penetrated axially by a throttling conduit forming the flow restrictor. With this configuration the control action of the control piston can be influenced by the operation of the hydromechanical signal transmitter.

### SUMMARY OF THE INVENTION

It is an object of the present invention to provide a borehole logging apparatus of the type initially referred to which enables the partial currents fed to the signal transmitter and the bypass opening to be adapted to different feed rates and drill string bores automatically and which enables the signal transmitter to produce sufficiently strong and significant pressure pulses at all feed rates.

It is further an object of the present invention to provide a borehole logging apparatus of this type in which the automatic adaptation of the partial currents fed to the signal transmitter and to the bypass opening to different feed rates and drill string bores is not affected by the operation of the hydromechanical signal transmitter.

According to the present invention the elongated housing accommodates in its interior a flow regulator having a control piston, which controls the current of drilling fluid through the bypass opening in response to the pressure differential generated at the entrance opening and to the force of a spring, in such manner that the drilling fluid current, which is fed to the signal transmitter, is maintained at levels optimal for the generation of significant pressure pulses, and the remaining excess drilling fluid current is routed to the drilling fluid conduit via the bypass opening. Advantageous embodiments are indicated in claims 2 to 5.

In the borehole logging apparatus of the present invention, the control piston detects the pressure differential occurring at the entrance opening of the housing due to throttling. As a result, the control movements of the signal transmitter and the attendant flow variations at the lower end of the housing conduit have no effect on the control action of the control piston. The borehole logging apparatus of the present invention is independent of the delivery rate of the drill fluid pumps within a wide working range and therefore also suitable for different drill string bores. By suitably designing the flow regulator, the drilling fluid current fed to the signal transmitter can be automatically adjusted to current values optimal for the generation of significant pressure pulses, which values are maintained during operation by means of a quantity-dependent regulation of the bypass cross-section. Depending on the amount of drilling fluid delivered, the bypass current can be between zero and a value equal to or even greater than the drilling fluid current fed to the signal transmitter. By virtue of the automatic, pressure-independent adaptation of the bypass current to fluctuating drill fluid delivery rates, interruptions of drilling operations, conversion work on the borehole logging apparatus and faults resulting from unfavorable bypass cross-sections are avoided.

According to the present invention, provision may furthermore be made for the measuring section of the control piston to be arranged in a chamber disposed upstream from the entrance opening in the housing, which chamber is divided into two compartments by the measuring section, whereof the first compartment, which is located at the end of the measuring section remote from the tappet, is connected to the drilling fluid conduit of the drill string through a connecting bore, and whereof the second compartment, through which the tappet extends, is connected to the end of the housing conduit close to the signal transmitter through a longitudinal bore, through which the tappet is passed, and receives therein a compression spring bearing against the measuring section with a spring force. The configuration of the invention permits integrating the flow regulator into the slim cylindrical housing of a borehole logging apparatus using simple, low-cost components while maintaining a large cross-section of flow hardly impeding the drilling fluid current. As a result, the outside diameter of the borehole logging apparatus can be kept so small as to be suitable for use with deep drilling standard bores of coupling size 2⅞″ and larger and to be withdrawable through the drill string from the derrick. The configuration of the invention furthermore ensures a minimum of abrasion because sharp turns in the drilling fluid current are avoided.

In order to achieve a favorable control characteristic it is possible for the compression spring to have a progressive characteristic. Alternatively, it is possible for the opening cross-section of the bypass opening to increase degressively as the travel of the control piston increases in the opening direction.

According to a further proposal of the invention, provision may be made for the control action of the control piston to be considerably dampened. This prevents the pressure pulses generated by means of the signal transmitter from setting the control piston in vibration, which would incur the risk of the control action and the service life of the flow regulator being impaired. Dampening is accomplishable simply by increasing the flow resistance needing to be overcome for filling and emptying the first and/or second compartment bounded by the measuring section.

The present invention will be explained in more detail in the following with reference to an embodiment illustrated in the accompanying drawings.

### BRIEF DESCRIPTION OF THE DRAWINGS

FIG. 1 is a longitudinal sectional view of a section of a drill string and a section of a borehole logging apparatus of the invention with flow regulator and hydromechanical signal transmitter; and

FIG. 2 is a cross-sectional view of the throttling section of the control piston of the borehole logging apparatus of FIG. 1.

### DETAILED DESCRIPTION

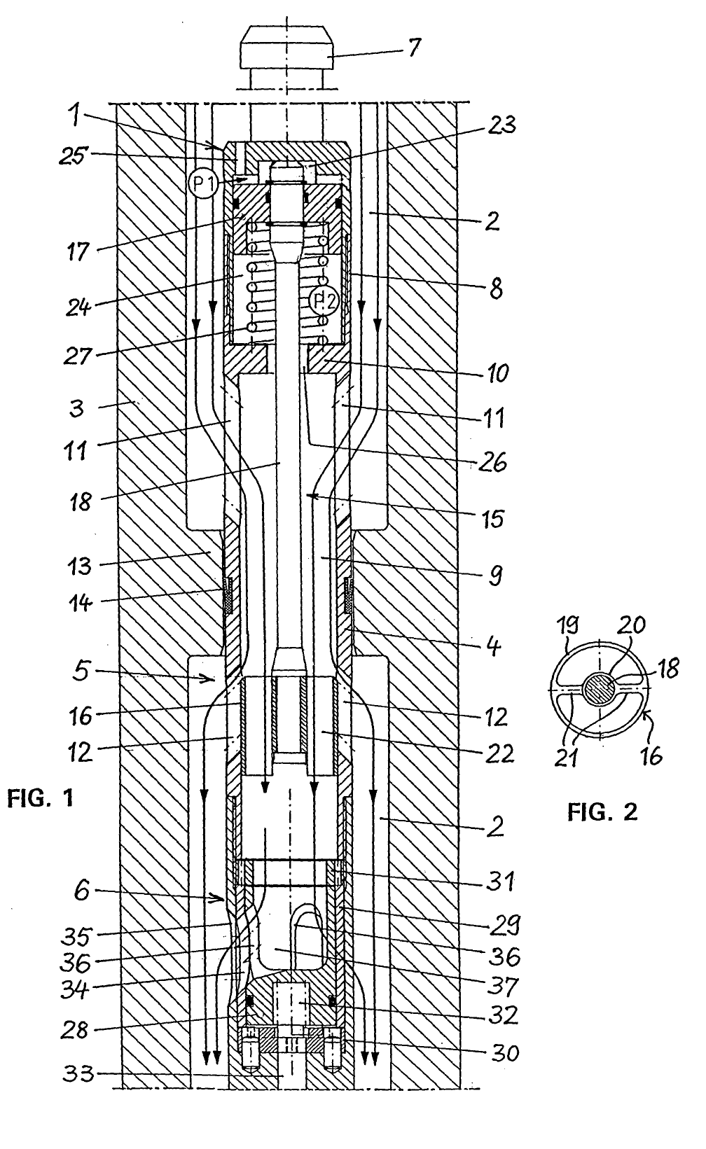

FIG. 1 shows the upper section of a borehole logging apparatus 1 arranged in the drilling fluid conduit 2 of a drill collar 3 of a drill string for deep well drilling. The borehole logging apparatus 1 comprises a housing 4 composed of several housing parts bolted together and having the form of an elongated cylindrical rod. Arranged in the section of the housing 4 shown are a flow regulator 5 and a hydromechanical signal transmitter 6, while further units such as the drive of the signal transmitter 6, a measuring probe, a measuring transducer, a signal generator and an energy storage are arranged in the lower section of the housing 4, not shown. Provided at the upper end of the housing 4 is a catch hook 7 by which the borehole logging apparatus 1 is held by means of a gripper to enable it to be lowered into the drill string on a rope or pulled out again.

The illustrated section of the housing 4 has at its upper end a chamber 8 and a downwardly adjoining housing conduit 9 separated from the chamber 8 by a wall 10 and receiving the signal transmitter 6 at its lower end. Beneath the wall 10 the housing conduit 9 is in communication with the drilling fluid conduit 2 through entrance openings 11 and above the signal transmitter 6 through bypass openings 12. The entrance openings 11 have the effect of a flow restrictor. Between the entrance openings 11 and the bypass openings 12 the drilling fluid conduit 2 is interrupted by a constriction 13 formed by the drill collar 3, and the housing 4 is sealed against the constriction 13 by means of a seal 14. The drilling fluid current conveyed through the drilling fluid conduit 2 is therefore forced to enter the housing conduit 9 through the entrance openings 11, leaving the conduit beneath the constriction 13 through the bypass openings 12 and/or the signal transmitter 6.

The flow regulator 5 comprises a control piston 15 having a throttling section 16 and a measuring section 17 which are interconnected by a tappet 18. The throttling section 16 is arranged in the housing conduit 9 in the area of the bypass openings 12 in such manner as to be able to close the bypass openings 12 or open them wholly or in part. The throttling section 16 is comprised of two concentric sleeves 19, 20 interconnected by two radial walls 21. The free annulus between the sleeves 19, 20 produces a conduit 22 through which fluid flow is directed to the signal transmitter 6. The measuring section 17 is longitudinally displaceably mounted in the chamber 8 and sealed against the chamber wall. It divides the chamber 8 into two compartments 23, 24. Several bores 25 extending through the housing 4 provide for communication between the compartment 23 and the drilling fluid conduit 2. A bore 26 through which the tappet 18 is passed provides for connection of the compartment 24 with the housing conduit 9. Furthermore, the compartment 24 houses a compression spring 27 acting upon the measuring section 17 with a spring force. The compression spring has a deflection characteristic by which the spring force increases progressively when the spring is compressed.

The signal transmitter 6 disposed at the lower end of the housing conduit 9 has a cylindrical, beaker-shaped rotor 28 and a stator sleeve 29 surrounding the rotor. The stator sleeve 29 is axially fixed in place in the housing 4 between an annular disk 30 non-rotatably arranged in the housing 4 and a threaded ring 31, and is maintained in a defined angular position in a manner preventing relative rotation by positive engagement of a claw within a recess in the annular disk 30. The rotor 28 is of an axial length less than the stator sleeve 29 and is equally mounted in the space between the annular disk 30 and the threaded ring 31. By means of a coupling 32 the rotor 28 is connected with a drive shaft 33 in a non-rotating relationship, taking support upon the drive shaft 33 in an axial direction so it is in a mid-position between the annular disk 30 and the threaded ring 31. As a result, the axial end surfaces of the rotor 28 are not in frictional contact with the opposite neighboring surfaces. The drive shaft 33 is mounted with zero play in axial direction in the downwardly adjoining section, not shown, of the housing 4 by means of rolling thrust bearings. The rotary motion of the rotor 28 is limited to an angle of rotation of, for example, 45° by claw-type projections on its bottom, which engage within recesses in the annular disk 30.

In the wall of the stator sleeve 29 provision is made for a symmetrical arrangement of passageways 34, with openings 35 of matching size being provided in the opposite wall of the housing 4. The passageways 34 and the openings 35 are separated from one another in the circumferential direction by respective closed wall portions. The wall of the rotor 28 is likewise provided with passageways 34 which, in the illustrated position of the rotor 28, lie opposite the passageways 34, the passageways being likewise separated from each other by closed wall portion 36. The circumferential dimensions of the passageways 34 and wall portions 37 are coordinated so that on a rotation of the rotor 28 through the predetermined angle of rotation the wall portions 37 close the passageways 34.

Serving to drive the rotor 28 is a reversible direct-current motor linked to the drive shaft 33 by means of a reduction gear and a flexible coupling. To generate pressure pulse signals the direct-current motor is powered by current of changing direction so that it periodically reverses its direction of rotation, moving the rotor 28 alternately into the illustrated passing position and into the closing position offset by an angle of 45°, for example. The respective end position of the rotor 28 is sensed by an angle-of-rotation transducer for control of the direct-current motor.

In operation, drilling fluid is conveyed through the drilling fluid conduit 2 of the drill collar 3 and the housing 4 of the borehole logging apparatus 1 in the manner illustrated in the Figure by the arrowed lines, with the drilling fluid current being produced by drilling fluid pumps connected to the drill string on the earth's surface. The drilling fluid current entering the housing conduit 9 at a pressure P1 is throttled to a pressure P2<P1 as it passes the entrance openings 22. The pressure differential P1−P2 becomes effective on the measuring section 17 of the control piston 15 and attempts to displace the control piston 15 in the direction of the signal transmitter 6 until the pressure forces and the force of the spring 27 counterbalance each other. The throttling effect of the entrance openings 11 and the force of the compression spring 27 are designed in relation to the hydraulic effective areas of the control piston 15 so that the pressure differential P1−P2 produced by the drilling fluid current in the presence of a low delivery rate is not sufficient to overcome the spring force, hence causing the control piston 15 to be maintained in its upper stop position and close with its throttling section 16 the bypass openings 12 up to a small minimum cross-section. Nearly the entire drilling fluid current is therefore routed through the signal transmitter 6 in order to enable it to produce sufficiently strong and significant pressure pulses. With the delivery rate of the drilling fluid current increasing, the pressure differential P1−P2 increases, too. By virtue of the higher pressure differential the control piston 15 is now moved downwardly against the force of the compression spring 27, and the bypass openings 12 are opened until the balance is reestablished. When the delivery rate of the drilling fluid current continues to increase, the control piston 15 opens the bypass openings 12 a wider amount, whereby the amount of bypass fluid increases. The amount of drilling fluid routed to the signal transmitter 6 through the conduit 22 also increases but the increase is lower and just high enough to enable the signal transmitter 6 to produce sufficiently strong and significant pressure pulses. Hence the flow regulator 5 is in a position to regulate the amount of bypass fluid between a minimum value and a maximum value determined by the maximum opening cross-section of the bypass openings 12. In the entire range of control the amount of drilling fluid fed to the signal transmitter varies to the extent to which the pressure differential P1−P2, which increases to overcome the progressively increasing force of the compression spring 27, effects an increase in the amount of drilling fluid passing through the conduit 22. The variation in the amount of drilling fluid fed to the signal transmitter 6 is low in comparison with the variation in the amount of bypass fluid. It can be influenced by the design of the spring characteristic of the compression spring 27. In this connection a progressive spring characteristic has proven to be advantageous for achieving a convenient control characteristic. The same effect can be accomplished with a configuration of the bypass openings that tapers conically in the direction of opening movement of the control piston.

I claim:

1. A borehole logging apparatus for deep well drilling comprising:
a device for transmitting from a borehole through the drilling fluid signals characteristic of measured data obtained while drilling the borehole,
a hydromechanical signal transmitter responsive to signals characteristic to the measured data for generating in the drilling fluid a coded series of pressure pulses characteristic of the measured data; and
a flow regulator for controlling the current of drilling fluid directed to the signal transmitter in response to a pressure differential generated by restricting the current of drilling fluid entering the device so that the current of drilling fluid directed to the signal transmitter is automatically adjusted to flow values optimal for the generation of significant pressure pulses.

2. The borehole logging apparatus as claimed in claim 1 wherein the compression spring has a progressive characteristic.

3. The borehole logging apparatus as claimed in claim 1 wherein the opening cross-section of the bypass opening increases degressively as the travel of the control piston increases in the opening direction.

4. A borehole logging apparatus for deep well drilling, comprising:
a device for transmitting from a borehole through the drilling fluid to the earth's surface signals characteristic of measured data obtained while drilling,
an elongated housing, which is adapted for insertion in the drilling fluid conduit of a drill string, includes at its influx end an entrance opening leading into a central housing conduit and has, downstream from the entrance opening, a sealing ring effecting a seal against the drill string,
said elongated housing further includes a bypass opening arranged downstream from the sealing ring and leading from the central housing conduit into the drilling fluid conduit of the drill string,
and a hydromechanical signal transmitter which is arranged in the elongated housing and has, downstream from the bypass opening, a passageway connecting the central housing conduit with the drilling fluid conduit of the drill string, and which controls a closure element by means of which the passageway is adapted to be throttled at least in part,
wherein said closure element is repeatedly movable, at intervals and in response to signals characteristic of measured data to be transmitted, from a passing position into a throttling position and back again into the passing position in order to generate in the drilling fluid a coded series of positive pressure pulses corresponding to the signals,
wherein the elongated housing accommodates in its interior a flow regulator having a control piston, which controls the current of drilling fluid through the bypass opening in response to the pressure differential generated at the entrance opening and to the force of a spring, in such manner that the drilling fluid current, which is fed to the signal transmitter, is maintained at flow values optimal for the generation of significant pressure pulses, and the remaining excess drilling fluid current is routed to the drilling fluid conduit via the bypass opening.

5. The borehole logging apparatus as claimed in claim 4 wherein the control piston has a throttling section controlling the cross-section of passage of the bypass opening, and a measuring section serving as a pressure sensor, and the throttling section and the measuring section are interconnected by a tappet.

6. The borehole logging apparatus as claimed in claim 5 wherein the measuring section is arranged in a chamber disposed upstream from the entrance opening in the elongated housing, which chamber is divided into two compartments by the measuring section, whereof the first compartment, which is located at the end of the measuring section remote from the tappet, is connected to the drilling fluid conduit of the drill string, and whereof the second compartment, through which the tappet extends, is connected to the housing conduit, through which the tappet is passed, and receives therein a compression spring bearing against the measuring section with a spring force.

7. The borehole logging apparatus as claimed in claim 4 wherein the compression spring has a progressive characteristic.

8. The borehole logging apparatus as claimed in claim 4 wherein the opening cross-section of the bypass opening increases degressively as the travel of the control piston increases in the opening direction.
